(19) United States
(12) Patent Application Publication
(10) Pub. No.: US 2025/0176575 A1
(43) Pub. Date: Jun. 5, 2025

(54) Method And System For A UHT Processing Of A Drinkable Plant-Based Food Product Under Sterile Conditions

(71) Applicant: GEA TDS GmbH, Sarstedt (DE)

(72) Inventors: Ludger Tacke, Velen (DE); Dennis Glinke, Hannover (DE); Lars Ricker, Suderburg (DE); Phillip Müter, Múnster (DE)

(21) Appl. No.: 18/714,836

(22) PCT Filed: Nov. 30, 2021
(86) PCT No.: PCT/EP2021/000151

§ 371 Date: Dec. 27, 2024

(51) Int. Cl. A23B 11/29; A23B 2/46; A23C 11/10; B01F 25/60; B01F 101/14; F28D 7/10

(52) U.S. Cl. CPC A23B 11/293; A23B 2/46; A23C 11/103; B01F 25/60; F28D 7/10; B01F 2101/14

(57) ABSTRACT

Described are a method and an ultra-high temperature (UHT) system for processing a drinkable plant-based food product under sterile conditions that ensure an extension of the service life in the production cycle and a higher production capacity in a specified period of time. In at least one section of the thermal treatment in which an admixture starts to precipitate from the material solution, i.e., the raw product, above a precipitation temperature, a first pulsed flow is applied to the product-side flow in the interior of a pipe in the course of a pressure increase process. The pulsed flow is superimposed on a second pulsed flow within the product-side flow in the interior of the pipe, where the second flow results from homogenization. The product-side flow in the interior of the pipe is exposed to a highly turbulent flow with a Reynolds number above 30,000.

### TECHNICAL FIELD

The invention relates to a method for UHT processing of a drinkable plant-based food product under sterile conditions. In the form of a raw product used, the food product preferably constitutes a homogeneous mixture of a carrier liquid, for example water, and at least one plantal substrate, which can be almonds, oats, or soya, for example. The homogeneous mixture is a so-called continuous phase. At least one solid admixture, a so-called dispersed phase, is to be additively fed into the continuous phase. Usually the dispersed phase with the continuous phase enters a material solution. The solid admixture can be, for example, calcium carbonate or another mineral nutrient suitable for human consumption. Until a drinkable finished product is produced the raw product is subjected, in the sequence mentioned in the following, to a thermal treatment at least by a pre-warming, a pre-heating, a high-heating, a heat-maintenance and a cooling, and in the course of the thermal treatment undergoes a homogenization, preferably under sterile conditions. In each instance, the thermal treatment occurs by indirect heat exchange between a product-side flow in the interior of a pipe and a heat carrier medium external to the pipe. Moreover, a UHT system with which the method is carried out is a subject-matter of the invention.

The method and the UHT system are suited and designed in a particular manner for thermally treating and producing a drinkable plant-based food product, such as a so-called almond, oat, or soy milk, wherein it is known that these food products impose special requirements on a UHT processing. At least one solid admixture, or also differently aggregated admixtures, can be admixed with the plant-based food product. For example, almond, oat, or soy milk can be enriched with calcium, and thereby constitute an alternative to conventional cow's milk.

In principle, the present invention is applicable to the thermal treatment and production of drinkable plant-based food products within the meaning stated in the preceding; it is set out concretely, qualitatively and quantitatively in the following description and based on an application example, namely an almond milk enriched with calcium.

The drinkable plant-based food product is enriched with calcium to simulate the naturally high amount of calcium in cow's milk. Even in the cold state, the calcium does not remain completely in solution, but rather precipitates out of the material solution with longer dwell time and without stirring.

Compared to almond milk, cow's milk has a calcium content of approx. 1000-1200 mg/litre (depending on feed, or respectively, season). A significant amount of the calcium in cow's milk, however, is bound in the casein micelles (protein) of the milk and thereby stable in solution. For this reason, the problem described in the scope of the invention is a problem exclusively affecting drinkable plant-based food products. Aside from temperature, the exact solubility of calcium in aqueous solution depends very highly on the presence of further mineral substances, including magnesium or phosphorus. In the literature, however, it is confirmed that solubility generally falls with increasing temperature (Morse, J. W., Arvidson, R. S., and Lüttge, A. Chem Rev. 2007 February; 107 (2): 342-381; Calcium Carbonate Formation and Dissolution).

### PRIOR ART

UHT systems of the category-defining type for heating almond milk enriched with calcium are known in which, with a heating of the product to a maximum of approx. 140° C. in a relatively short time, for example, in a maximum possible production time of approx. 2.5 hours, there is increased product fouling above a temperature of approx. 110° C. in the so-called shell-and-tube heat exchangers used for heating. Product fouling is understood to mean film formation, or respectively, the deposits on heating surfaces of the heat exchanger that are charged with product, in the present case on the interior side of the product-conveying pipes, in the least favorable case, it means a burning-on of the product. The heat transfer, from the heat carrier medium outside the pipe, steam or hot water, for example, to the product in the interior of the pipe, determined by the so-called heat transfer number or so-called heat transfer coefficient, and thus necessarily the heat permeation, determined by the so-called heat permeation number or so-called heat permeation coefficient, is significantly deteriorated in this section due to the product fouling. This reduction is illustrated by a temperature difference (the so-called Delta-T; ΔT) in the shell-and-tube heat exchanger required for transferring the necessary heat from the heat carrier medium to the product.

The considerably quicker film formation in almond milk enriched with calcium is caused by the precipitation of calcium from the material solution as the temperature rises, since the solubility of calcium decreases with rising temperature. The precipitated calcium, but also other additive admixtures, such as other (mineral) substances, for example, tend(s) toward sedimentation on the inner tube wall. The calcium does not remain completely in solution even in the cold state, but rather precipitates with longer dwell time, when not stirred. In the UHT method, the introduced raw product is therefore constantly mixed to prevent sedimentation and to promote a homogenous distribution.

With a so-called shell-and-tube heat exchanger, a number of inner tubes connected in parallel that are arranged in a specialized tube assignment pattern constitute a common inner channel through which the product flows, wherein the inner tubes in their totality are enclosed by a jacket pipe, which on the inside forms an outer channel charged with the heat carrier medium. The rapid growth of the film formation in the inner tubes charged with the product can be identified, on the one hand, by the rapidly increasing counter pressure and on the other hand, by the temperature difference mentioned in the preceding in the shell-and-tube heat exchanger(s) of the pre-heating and/or high-heating.

In the prior art UHT systems being discussed, after a production time of maximum 2.5 hours, due to the disadvantages mentioned in the preceding and past experience, either a sterile interim cleaning of the UHT system (approx. 1 hour time loss) or a main cleaning of the UHT system by means of a so-called CIP cleaning (“cleaning in place”) with acid/base and then water sterilization is required (time loss approx. 4 hours) before a further production cycle can be started.

It is an object of the present invention to create a method and a UHT system of the category-defining type that remedies the disadvantages of the prior art, by which on the one hand an extension of the service life in the production cycle, and on the other hand a higher production capacity in a specified period of time, are ensured using rinsing and cleaning measures to which independent inventive features are attributed.

### SUMMARY OF THE INVENTION

This object is solved by a method with the features of claim 1. Advantageous embodiments of the method are the subject-matter of the sub-claims. A UHT system for carrying out the method according to the invention is a subject-matter of co-ordinated claim 13. Advantageous embodiments of the UHT system are subject-matter of the associated sub-claims. Furthermore, a drinkable plant-based food product is indicated, such as almond milk enriched with calcium, which can be produced by using the method according to the invention and by means of the UHT system according to the invention.

Starting from the category-defining features of a UHT processing, the basic inventive concept is to inhibit product fouling, i.e. the emergence of the film and the speed of growth of the film on the product-guiding walls of the heat exchanger in the critical sections of the UHT processing. This is accomplished in that the substrates and or the precipitated admixtures that constitute the film, or respectively, deposits, are kept floating in the carrier liquid such that they do not conglomerate with one another and do not deposit, or respectively, stick to the walls of the product-guiding inner tubes.

The sterile conditions required for producing the drinkable plant-based food product are ensured in the known manner by realizing a product-specific temperature profile in the UHT method. This includes a pre-warming of the raw product used, possibly in multiple stages, a subsequent pre-heating and a high-heating in connection with a heat-maintenance with, in each instance, a UHT profile (specialized temperature/time curve) and a subsequent cooling, also possibly in multiple stages, to storage or filling temperature. In the course of the thermal treatment, the raw product is subjected to homogenization. If the homogenization occurs in the course of the cooling, i.e. downstream from the high-heating and heat-maintenance, then it is a homogenization under aseptic conditions. The precipitation of the at least one admixture from the carrier liquid, the calcium from the almond milk in the exemplary embodiment, takes place in the high-heating and, possibly, already in the pre-heating following the pre-warming, the pre-heating having been referred to as a critical section in the preceding, if the precipitation temperature is reached there. For almond milk enriched with calcium, the precipitation temperature is above approx. 110° C.

A first solution element of the present invention is that at least in one section of the thermal treatment, in which the at least one admixture begins to precipitate out of the material solution, the raw product, above a precipitation temperature, on the one hand a first pulsed flow is applied to the product-side flow in the interior of the pipe in the course of a pressure increase process using a pressure-increasing pump. On the other hand, this first pulsed flow is superimposed on a second pulsed flow within the product-side flow in the interior of the pipe, said second flow resulting from the homogenization carried out by means of a homogenizer, which preferably works under aseptic conditions because the pressure-increasing pump delivers against the homogenizer.

The pressure-increasing pump can be any type of positive displacement pump with a translational or rotational working principle. An essential suitability criterion for a pressure-increasing pump in this context is the generation of a controllable pulsed volumetric flow delivery and the generation of a system pressure that is unusually high for UHT systems as such, in particular in the critical section of the UHT system, beginning at the outlet of the pressure-increasing pump. The unusually high system pressure required is primarily due to a further solution feature according to the invention, which is discussed in the following.

A further solution element is that the turbulence of the flow in the interior of the pipe is additionally forced compared to designs according to the prior art, in that the flow in the interior of the pipe is designed for a highly turbulent flow with a Reynolds number above 30,000 (Re>30,000). The film formation and the speed of its growth are significantly reduced by this forced turbulence as a result of the three-dimensional flow field, which causes an amplified transverse movement in the flow in the interior of the pipe. It has been shown that to satisfy the requirements discussed in the preceding, the Reynolds number should be designed within a value range between 35,000 and 80,000 (35,000≤Re≤80,000) and particularly preferably between 50,000 and 80,000 (50,000≤Re≤80,000).

For ensuring the highly turbulent flow, it is further suggested to ensure the required Reynolds number by an increased flow speed above 2.5 m/s (c*>2.5 m/s) in case of need, preferably above 3.0 m/s. This necessity occurs when due to the sizing of the pipe geometry influencing the flow in the interior of the pipe (relatively small pipe interior diameter) in the critical section, the required Reynolds number cannot be achieved with the usual flow speeds in the range below 2 m/s. Prior art systems are generally designed for flow speeds below 2 m/s in the critical section. The unusually high system pressure allows for the features according to the invention to be present in the critical section, which are the highly turbulent flow, on the one hand, and the increased flow speed, on the other hand.

It has been found particularly expedient with regard to inhibiting the film formation when first pulse maximums relating to the volume flow of the first pulsed flow and second pulse maximums relating to the volume flow of the second pulsed flow are different in size. Furthermore, it is advantageous for first pulse maximums relating to the volume flow of the first pulsed flow to have a first pulse frequency and second pulse maximums relating to the volume flow of the second pulsed flow have a second pulse frequency, and the first and the second pulse frequency are different in size. A combination of the two design criteria proposed in the preceding (pulse maximums and pulse frequency) is especially effective with regard to inhibiting the film formation and for reducing the speed of its growth.

It is especially advantageous when the first pulse frequency of the first pulsed flow is smaller than the second pulse frequency of the second pulsed flow. In the production of almond milk enriched with calcium, especially good results are obtained when the first pulse frequency has a 3 to 5 relationship to the second pulse frequency (first pulse frequency/second pulse frequency=3/5).

The inhibition of the film formation and the speed of its growth using the features of the method according to the invention brings about a service life of the UHT system according to the invention, operated with the UHT method according to the invention and applied to almond milk enriched with calcium (hereinafter referred to as “raw product”), which at 8 hours is significantly longer than the service lives attainable with prior art UHT systems (max. approx. 2.5 hours). In prior art UHT systems, an interim or chemical main cleaning is required after the mentioned service life of 2.5 hours for returning the heat penetration conditions to the initial state of the production cycle. A service life of more than 8 hours can only be realized, however, when a sufficient quantity of raw product can be prepared and available in the UHT system for this production period.

The at least one admixture to drinkable plant-based food products, for example almond milk, oat milk and soya milk, can precipitate from the material solution at the so-called precipitation temperature during the high-heating and, possibly already in the pre-heating. For almond milk enriched with calcium, the precipitation temperature is located above approx. 110° C. in the so-called critical section, and serves as a criterion for applying the features according to the invention. For other drinkable plant-based food products, the critical section in this regard is to be located at a comparable, or even a different, precipitation temperatures.

Among the boundary conditions with regard to quantitative preparation of raw product according to the prior art, the invention proposes a rinsing and cleaning process according to the invention, to be performed after processing the usual preparation quantities of raw product using the UHT method according to the invention, which avoids, or respectively replaces with the same effect as, the interim or chemical cleaning.

This solution, which is accorded its own inventive significance, consists in that upon reaching
a prescribed pressure difference, relative to an initial pressure at the outlet of the pressure increasing pump, and
a prescribed temperature difference between the raw product and a separate heat carrier medium in the high-heating, or respectively in the critical section, relative to an initial temperature difference,
   the following steps (i) to (iv) are provided:
(i) first discharging of the finished product from the UHT system into a sterile tank arranged outside the UHT system by means of water;
(ii) second discharging of a mixed phase of finished product and water into a gully bypassing the sterile tank by means of a subsequently defined quantity of water
(iii) circulating water within the UHT system contaminated with raw and/or finished product for a circulation time that results from the complete elimination of the pressure difference to the initial pressure and of the temperature difference to the initial temperature difference, and
(iv) transitioning the UHT system into renewed production readiness for a prepared batch quantity of raw product.

The water used can be fresh water of special quality, but also in usual cases can be water without special quality and purity requirements, because when steps (i) to (iv) are carried out, this water undergoes the UHT processing with the temperature profile of the production cycle and is thus sterilized in the system.

At 2.5 hours, the production time for the raw product in the application example of almond milk enriched with calcium is determined by the batch quantity of the prepared raw product. During this time, the pressure rises at the outlet of the pressure increasing pump (pressure difference relative to an initial pressure) and a temperature difference occurs in the critical section, which is higher than an initial temperature difference. This means that there is already significant film formation in the critical section of the UHT system (>110° C.), which significantly reduces the heat penetration, or respectively heat penetration number. To realize the heating temperature continuously, the temperature on the heat carrier side thus increases, evident by increased steam use.

After the end of production, a first discharging of the raw product from the UHT system into a sterile tank is effected using water (product is discharged from the system using water). Due to the flow design of the heat exchanger, preferably shell-and-tube heat exchanger, in the course of a following second discharging, a mixed phase of discharge water and residual product is minimized, whereby product losses are therefore limited to a minimum. After the second discharging of the mixed phase, a defined quantity of water is pushed into a gully bypassing the sterile tank.

The system then enters circulation (“water circulation”), i.e. water is circulated in the UHT system, whereby the UHT system remains sterile and in constant production readiness. The circulation time required for this is less than 30 minutes based on experience. The required circulation time is determined by the extent of cleaning of the UHT system. It ends when the pressure difference is reduced to the initial pressure and the temperature difference is reduced to the initial temperature difference (two indicators for soiling of the UHT system), i.e. when the critical section is completely cleaned of film (starting state as after a chemical system cleaning, e.g. CIP cleaning).

According to an advantageous embodiment of the method, the rinsing and cleaning process is further optimized in that
in the course of the circulating, the circulated volume flow of water is incrementally reduced by the pressure increasing pump in conjunction with the homogenizer,
the decrease of the pressure difference and of the temperature difference in this context is monitored and in each case maximum gradients are determined, and
the circulating is continued under the circulation conditions at the optimum of the determined maximums until the initial pressure and the initial temperature difference are reached.

By the incremental reduction of the volume flow of water in the course of the circulating, moreover, a pulse frequency that slightly changes over time of the first and the second pulsed flow is generated (varying flow profile with various first and second pulse frequencies and first and second pulse maximums relating to the volume flow), wherein these variations have a positive effect on the dissolution of the film. The reduction in pressure difference and temperature difference is monitored and in each case the maximum gradients of these reductions are determined. The “optimal pulse frequency” is reached at the optimum of the determined maximums. This optimal pulse frequency can be determined and used for further control interventions through the monitoring of the reduction in the pressure and temperature difference during the circulating. At the place of the largest gradient in the reduction of the pressure and temperature difference, it can be presumed that the flow profile prevailing in this moment optimally augments the dissolution of the film. This ideal point can be both at the maximum as well as at the reduced circulation volume flow or can vary according to the type and resilience of film. Moreover, the energy use is further reduced through the reduction in the volume flow of the circulated water such that the UHT system meets the requirements for an efficient process plant.

In summary, with the rinsing and cleaning process according to the invention in conjunction with the design of the UHT system according to the invention, the following advantages result:
The UHT method meets the requirements of a modern, future-oriented UHT application for producing a drinkable plant-based food product under sterile conditions in every regard, because
the proposed UHT method guarantees a maximum product quality (sensory characteristics, stability, shelf life) even with long production cycles that are significantly greater than the prior art;
a significant efficiency increase is given due to omission of cleaning and sterilization steps;
the energy demand, which is accorded a constantly growing significance from the perspective of the system operator, is considerably reduced since the number of cleanings and the resterilizations associated therewith is considerably reduced and moreover, the volume flow during the water circulation can be reduced (topics: increasing energy prices; emissions reduction; acquisition of CO2 certificates; striving for climate neutrality as a company philosophy as well as advertising element).

The category-defining features of the UHT system as given in the preamble of the co-ordinated claim are known in principle. The operating parameters are in each case dependent on the product to be produced, its formula and on the specific operating parameters of the components and aggregations used in the UHT system. For example, in prior art UHT systems it suffices if a suitable pumping device, generally a rotary pump, is used for generating the volume flow through the heat exchangers placed in series and for overcoming the pressure losses.

The UHT system for carrying out the UHT method according to the invention implements the solution features of the method consistently in physical features. In the known manner, the UHT system ensures the sterile production conditions to be demanded by realizing a product-specific temperature profile. As part of this, the following list is chosen as an example and not mandatory, a pre-warming zone that has at least a first and, if necessary, a second heat exchanger in the pre-warming zone. In the usual case, this at least one heat exchanger is designed as a shell-and-tube heat exchanger and is preferably operated regeneratively. Next, seen in the flow direction of the raw product, there is a pre-heating zone which has at least one third heat exchanger of the pre-heating zone, preferably operated using a separate hot water circuit, a high-heating zone, which has at least one heat exchanger of the high-heating zone operated using a separate hot water circuit, a heat-maintenance zone, that has at least one heat-maintainer, a cooling zone that has at least one heat exchanger, preferably operated regeneratively, as well as heat exchangers of the cooling zone charged with direct water (cooling water and, possibly ice water), and a homogenizer in the course of the thermal treatment.

The following identifying features are provided for solving the object according to the invention, starting from the category-defining features of the UHT system:
a feed tank is provided which is fluidically connected with the first heat exchanger of the pre-warming zone via a supply line in which a pumping device is arranged, preferably a rotary pump;
a supply line for water flows into the supply line upstream of the pumping device;
the feed tank is integrated in fluid communication into a circulation line system that comprises the heat exchangers and the heat-maintainer up to a sterile tank and a fifth line segment circumventing the sterile tank by bypass leading to the feed tank;
a pressure increasing pump is arranged downstream from the first heat exchanger of the pre-warming zone, and the homogenizer is arranged downstream from the first heat exchanger of the cooling zone.

For realizing the rinsing and cleaning process of the UHT system with water via the circulation line system, the invention proposes that in the in-flow section of the fifth line segment in the feed tank, an outflow line flows out to a gully from the fifth line segment.

For generating an effective first pulsed flow, the pressure increasing pump is designed, for example, as a reciprocating pump with, for example, three single-acting pistons. The pressure increasing pump works in series on the homogenizer, which as is also provided, generates a second pulsed flow through a design as, for example, a reciprocating pump with, for example, five single-acting pistons. Instead of reciprocating pumps, other positive displacement pumps with a translatory or rotary working principle with multiple, time-delayed volume flow delivery can also be provided.

To meet the flow-mechanical requirements of the method, it is furthermore provided that the pressure-increasing pump is designed for a counter pressure that ensures the Reynolds number of claim 1 or 2, or the increased flow speed of claim 3 or 4, and that the sections of the UHT system charged with product between the pressure increasing pump and the homogenizer are designed for this counter pressure. The counter pressures necessary in this regard are in the range of 30 to 100 bar, based on experience.

The expedient inventive solution concept is the generation of a “pulsed flow” through the use of two pumps in series, a pressure increasing pump and a homogenizer that have the suitability criteria defined at the outset, preferably variable-speed positive displacement pumps with a translatory or rotary working principle and preferably reciprocating pumps here with, in each case, multiple single-acting pistons, wherein the pressure increasing pump preferably works with 3 pistons, for example, and the second pump, the homogenizer, preferably works with 5 pistons, for example. The “pulsed flow” ensures high turbulence inside the critical section and thus enables the deposited at least one admixture to be “carried along”. The 3-piston machine is equipped with larger pistons and a larger piston stroke than the 5-piston machine, such that a piston stroke of the 3-piston machine can pump a larger volume than the piston stroke of the 5-piston machine. To satisfy the continuity condition with regard to an identical average volume flow, the machines run at approximately identical rotational frequency. Nevertheless, due to their nature the machines do not generate a completely continuous passage but rather pump with different pulse maximums in each case. These are different in the 3-piston machine from those in the 5-piston machine. The pulsed flow is originally generated by the 3-piston machine because it pumps against the 5-piston machine. Since, as discussed, the pulse maximums are not the same, a pulse arises inside the volume flow.

The high flow speeds, as provided according to the invention for generating the required Reynolds number, which go beyond the usual measure in the prior art, in conjunction with the low viscosity of the water, ensure a high turbulence of the flow. The transverse movement (three-dimensional flow field) of the liquid thus achieved augments the effect of the (primarily) mineral fouling being “carried along”, or respectively, detaching.

Upon entry into the UHT system, the water contains no admixture, for example, no calcium, for which reason the admixture deposited in the system can go into solution in the water and thus can be discharged via the water in the course of the cleaning and flushing process.

The invention further proposes that in each case the shell-and-tube heat exchangers have inner tubes that have the features of the subject-matter of the document EP 1 567 818 B1. Screw thread-shaped, raised or depressed profiles are formed at least on the surface of the inner wall of the inner tubes. This measure serves to increase turbulence compared to the smooth tube and with sufficient sizing of the raised profiles in particular, generates a flow component in the circumferential direction desired within the scope of the turbulence. From heat transfer engineering, improving the heat transfer compared to the so-called smooth tube by profiling the heat-transferring tube inner surfaces and tube outer surfaces is known. For this purpose, the screw thread-shaped depressions mentioned in the preceding are implemented in the tube wall by forming techniques, by which no additional material thickness is required for generating these desired macro-roughness structures.

This means that a depression applied to the outside represents a corresponding augmentation on the inside. The thin-walled pipes thus deformed are termed so-called twist pipes. The coiling of the inner tubes (depth and angle of the coiling) known from the document cited in the preceding is adapted in all heat exchangers for increasing the turbulence and the reduced product fouling induced by this is adapted to the high flow speeds and further solution features according to the invention.

The proposed method and the UHT system are especially suited for producing a drinkable plant-based food product under sterile conditions, such as almond milk enriched with calcium. This almond milk consists
of the continuous phase
   which consists of a homogeneous mixture of a carrier liquid and at least one plantal substrate,
      wherein the plantal substrate is produced from almonds softened in a liquid provided for this purpose, such as water, then pressed or milled, and the plantal substrate is mixed into and homogeneously distributed in the carrier liquid, such as water, with a dry substance content of preferably 5 to 10%,
and the dispersed phase,
   which consists at least of one solid admixture, with preferably 1,800 to 2,000 mg calcium carbonate/liter of continuous phase,
wherein the dispersed phase with the continuous phase enters into a material solution in the form of the raw product,
and is produced by application of the method according to one of claims 1 to 12 or through thermal treatment in the UHT system according to one of claims 13 to 18.

The almond milk preferably has a dry substance content of approx. 5%-(10%) (cf. cow milk: approx. 13% incl. 3.5% fat). The almond milk is homogeneous and storage-stable before calcium enrichment and has only minimal calcium sedimentation. Aside from the “pure” variety, the almond milk product is also available in various flavours, including chocolate. The pH value of the almond milk is in the slightly alkaline range (7.3-7.6; slight reduction during storage through to the end of the product shelf life). A dry substance content of 10 to 18% is not unusual in almond, oat and soy “milks”, however.

For the aforementioned and also other drinkable plant-based food products, the features specified in the exemplary embodiment for the almond milk can vary significantly in a wide range according to the quantity and type of plantal substrate, and the admixtures can also vary significantly according to quantity and type. The advantages of the method according to the invention and the UHT system for carrying it out are also brought to bear in a special manner for these drinkable plant-based food products.

### BRIEF DESCRIPTION OF THE DRAWINGS

A more detailed depiction of the invention results from the following description and the attached figures of the drawing, as well as from the claims. While the invention is realized in the most varied embodiments, a preferred exemplary embodiment of the UHT system with which the UHT method according to the invention can be carried out is depicted in the drawing and described below according to structure and function.

FIG. 1 a schematic depiction of a relevant partial section of a UHT system according to the invention that is reduced to essential features;

FIG. 2 a schematic depiction of the product cycle according to the invention for producing the finished product FP with the UHT system according to FIG. 1;

FIG. 3 a schematic depiction of the first discharging of the finished product FP according to the invention from the UHT system according to FIG. 1;

FIG. 4 a schematic depiction of the second discharging of the mixed phase according to the invention from the UHT system according to FIG. 1 in conjunction with an overrun of a certain quantity of water;

FIG. 5 a schematic depiction of the circulating of the water according to the invention in the scope of the cleaning and rinsing process according to the invention in the UHT system according to FIG. 1, and

FIG. 6 a simplified graphic depiction of the features of the first and of the second pulsed flow in the scope of the UHT system according to FIG. 1.

### DETAILED DESCRIPTION

### UHT System

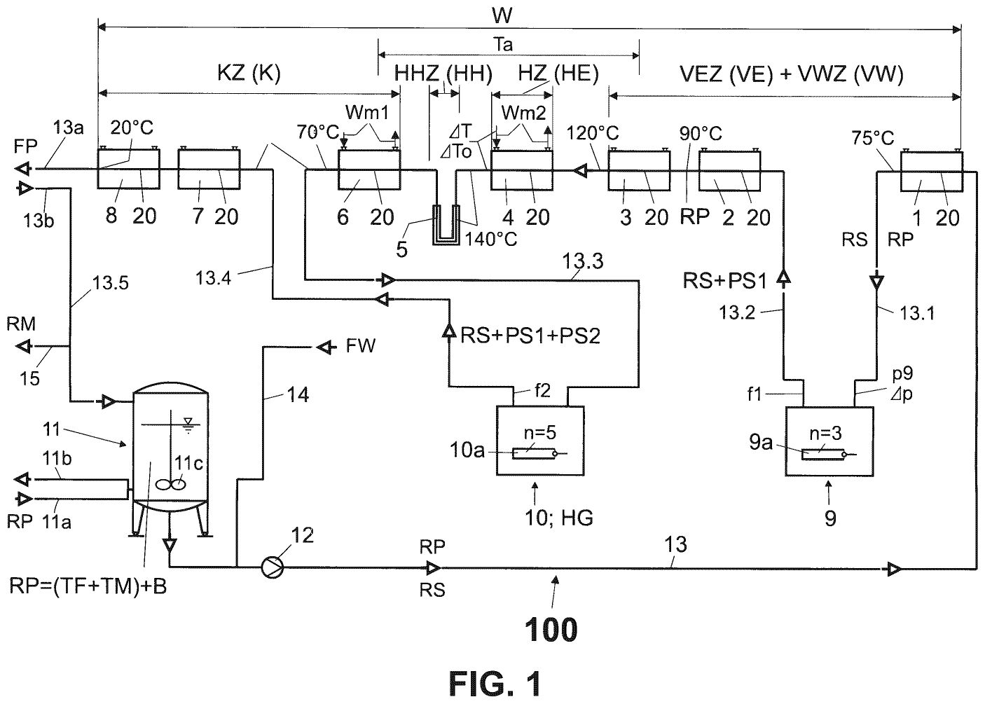

A partial section 100 of a UHT system (UHT: Ultra High Temperature) depicted in FIG. 1, starting from a supply line 13 in which a raw product RP to be treated, for example a drinkable plant-based food product, as in the present case almond milk enriched with calcium, constitutes in a known manner a flow RS in the interior of the pipe, in the depicted flow direction from a pre-warming zone VWZ, a pre-heating zone VEZ, a high-heating zone HZ, a heat-maintenance zone HHZ and a cooling zone KZ. For the purpose of thermal treatment W of the raw product RP through to a finished product FP at an outlet 13a to a sterile tank (not shown), the zones have heat exchangers 1-4 and 6-8 placed in series, which preferably are designed as so-called shell-and-tube heat exchangers. The number of heat exchangers is chosen as an example and for simplicity; in the real embodiment of the UHT system, more than one heat exchanger can be concealed behind each of these schematically depicted heat exchangers.

The respective shell-and-tube heat exchanger is preferably a variant as described in DE-U-94 03 913 (schematic Tuchenhagen Dairy Systems GmbH, Ahaus) and in which multiple inner tubes 20 placed in parallel are provided preferably in the form of a special tube assignment pattern, which the raw product RP flows through in the present exemplary embodiment while a heat carrier medium Wm1, Wm2, usually hot water or steam, flows in the opposite direction in the annular gap space (outer channel) of a jacket pipe (outer jacket) which surrounds the inner tubes 20 placed in parallel in their entirety. The inner tubes 20 preferably have the features of the subject-matter of EP 1 567 818 B1.

In the exemplary embodiment, the pre-warming zone VWZ for pre-warming VW has, for example, a first and a second heat exchanger 1, 2 of the pre-warming zone, which both are preferably operated regeneratively with a regenerative heat carrier medium Wm1 (preferably water). In the heat exchangers 1 and 2, a pre-warming VW of the raw product RP takes place by stages to temperatures of approx. 75° C. and approx. 90° C. A pre-heating zone VEZ follows next, with a third heat exchanger 3 of the pre-heating zone, which is preferably charged via a separate hot water circuit and heats the raw product RP to a temperature of approx. 120° C. In the real embodiment, the third heat exchanger 3 of the pre-warming zone consists, for example, of three separate heat exchangers. In the subsequent high-heating zone HZ, at least one heat exchanger 4 of the high-heating zone is provided, which is preferably integrated into a separate hot water circuit and heats the raw product RP through high-heating HE to a temperature of approx. 140° C. In a heat-maintainer 5 of the heat maintaining zone HHZ, heat maintenance HH of the raw product RP takes place at the temperature of approx. 140° C. for a certain time. Following the heat-maintaining zone HHZ comes the cooling zone KZ in which the raw product RP is cooled K to a ready-to-drink sterilized finished product FP to a temperature of approx. 70° C. and finally approx. 20° C. For this purpose, a first heat exchanger 6 of the cooling zone, for example operated regeneratively, and if necessary, a second heat exchanger 7 of the cooling zone charged with cool water, and also if necessary, a third heat exchanger 8 of the cooling zone charged with ice water are provided. The second and the third heat exchangers 7 and 8 of the cooling zone are only mentioned here as an example. Depending on the application, the UHT system can also be operated only with one of the two or without these two.

Between the first and the second heat exchangers 1, 2 of the pre-warming zone, a pressure increasing pump 9 is provided, preferably a positive displacement pump with a translatory or rotary working principle, and here preferably a reciprocating pump with three (n=3) single-acting first displacers 9a, a so-called 3-piston machine which in the exemplary embodiment (UHT processing of almond milk enriched with calcium) is designed for an unusually high maximum counter pressure of 80 bar. Depending on the dimensioning of the inner tubes in the critical section, the maximum counter pressure can be designed in a range between 30 and 100 bar.

Between the first and the second heat exchangers 6, 7 of the cooling zone, via a third and a fourth line segment 13.3, 13.4, a homogenizer 10 is provided which in this arrangement works under aseptic conditions downstream from the high-heating HE and heat-maintenance HH. In the exemplary embodiment, preferably a reciprocating pump with five (n=5) single-acting second displacers 10a is proposed, a so-called 5-piston machine. The number of pistons is generally dependent on the volume flow to be pumped and can differ, greater or lesser, than the number chosen in the exemplary embodiment. The pressure-increasing pump 9 pumps against the homogenizer 10, which is why the product-charged regions of the UHT system 100 between the pressure-increasing pump 9 and the homogenizer 10 are designed for a system pressure of 80 bar as mentioned in the preceding.

The UHT system 100 has a feed tank 11 with a stirring and mixing apparatus 11c, which is fluidically connected to the first heat exchanger 1 of the pre-warming zone via the supply line 13, in which a pumping apparatus 12, preferably a rotary pump, is arranged. A supply line 14 for water flows into the supply line 13 upstream from the pumping apparatus 12, via which supply line 13 water FW is supplied in case of need. The feed tank 11 furthermore has an inlet to and an outlet from 11a, 11b the feed tank via which the raw product RP can be fed in and led away. The feed tank 11 is integrated by fluid communication into a circulation line system that comprises the heat exchangers 1-4 and 4-8 and the heat-maintainer 5 through to the sterile tank (not shown) and a fifth line segment 13.5 circumventing the sterile tank by bypass and leading to the feed tank 11 via an inlet 13b, and comprising the supply line 13. The pressure increasing pump 9 described in the preceding and arranged downstream from the first heat exchanger 1 of the pre-warming zone and the aseptically working homogenizer 10 provided downstream from the first heat exchanger 6 of the cooling zone are integrated in the circulation line system.

In the flow-in region of the fifth line section 13.5 in the feed tank 11, an outflow line 15 to a gully for residual product RM flows out of the fifth line segment 13.5.

### Method

With the method described in the following, a drinkable plant-based food product, the raw product RP used, can be subjected to a UHT processing for producing a drinkable finished product FP with the UHT system 100 (FIG. 1) described in the preceding. The following method description is based on concrete process data obtained in the production and treatment of an almond milk enriched with calcium.

The raw product RP used consists of a continuous phase TF+TM and a dispersed phase B. The continuous phase TF+TM constitutes a homogeneous mixture of a carrier liquid TF, preferably water, and at least one plantal substrate TM, wherein the plantal substrate TM is produced from almonds softened in a liquid provided for this purpose, such as water, then pressed or milled. The plantal substrate TM is mixed into the carrier liquid TF with a dry substance content of preferably 5 to 10% and preferably homogeneously distributed. The dispersed phase B consists of at least one solid admixture B, which is fed into the continuous phase TF+TM (RP=(TF+TM)+B), for example, with 1800 to 2000 mg calcium carbonate. The dispersed phase B with the continuous phase TF+TM usually enters into a material solution in the form of the raw product RP.

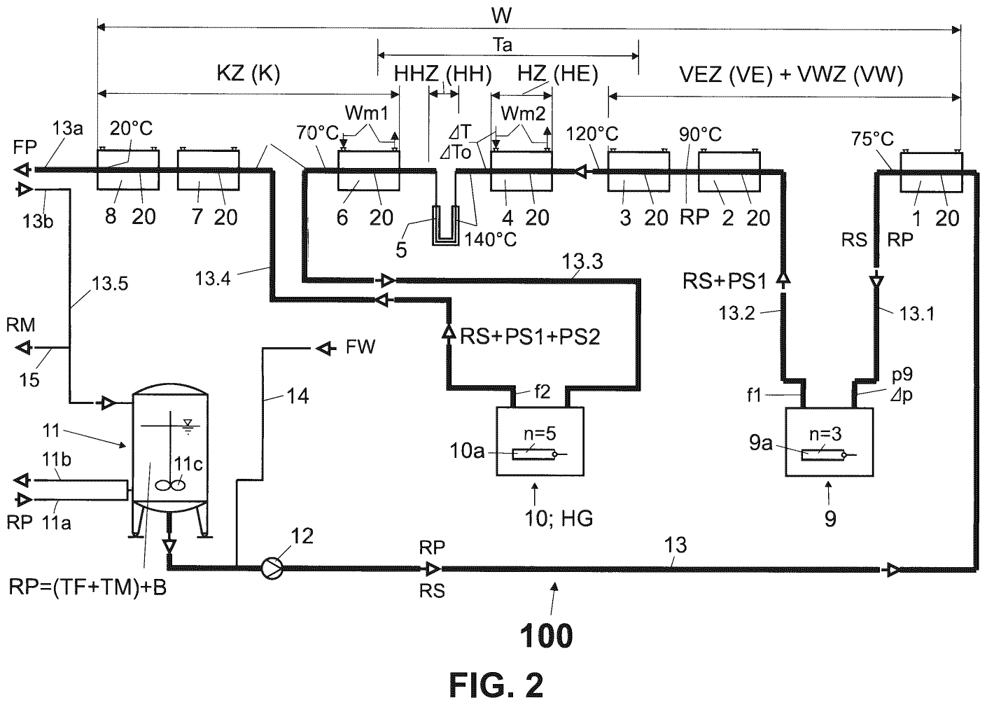

The raw product RP is placed in the feed tank 11 and is constantly stirred there by means of the stirring and mixing apparatus 11c (FIGS. 1 and 2). In the production cycle (FIG. 2), the raw product RP is led away from the feed tank 11 by means of the pump apparatus 12 and is supplied to the first heat exchanger 1 of the pre-warming zone via the supply line 13.

In the course of its treatment into a drinkable finished product FP, the raw product RP undergoes the thermal treatment W through indirect heat exchange in each case between the product-side flow in the interior of the pipe RS of the respective inner tube 20 and the heat carrier medium Wm1, Wm2 external to the pipe.

In the sequence stated in the following, the thermal treatment W consists at least of the pre-warming VW with the preferably regeneratively operated heat exchangers 1 and 2 of the pre-warming zone, the pre-heating VE with the heat exchanger 3 of the pre-heating zone preferably operated with a separate hot water circuit, the high-heating HE with the heat exchanger 4 of the high-heating zone preferably operated with a separate hot water circuit, the heat-maintenance HH with the heat maintainer 5, and the cooling K with the heat exchangers 6, 7 and 8 of the cooling zone, wherein the at least one heat exchanger 6 is preferably operated regeneratively and the heat exchangers 7 and 8 with direct water, preferably cool water and ice water. In the course of the cooling K, a homogenization HG takes place in the homogenizer 10 (FIGS. 1, 2), which in the exemplary embodiment is carried out under aseptic conditions.

At least in the critical section of the thermal treatment W in which above a precipitation temperature Ta, the at least one admixture B, the calcium in the present application example, begins to precipitate from the material solution RP (see FIG. 1, 2; section is approximately marked), a first pulsed flow PS1 is applied to the flow in the interior of the pipe RS, on the one hand, as part of a pressure increase by means of the pressure increasing pump 9, said pulsed flow PS1 being superimposed on a second pulsed flow PS2 within the flow RS in the interior of the pipe, said second flow resulting from the homogenization HG carried out by means of the homogenizer 10 (FIG. 1, 2). For calcium, the precipitation temperature Ta is above approx. 110° C. A further inventive measure in the method is that in the critical section, the flow RS in the interior of the pipe, on the other hand, is designed for a Reynolds number Re above 30,000 (Re>30,000), preferably in a value range between 35,000 and 80,000 (35,000≤Re≤80,000) and particularly preferably between 50,000 and 80,000 (50,000≤Re≤80,000).

If the geometrical dimensional relationships of the inner tube 20 do not make it possible to achieve the required Reynolds number Re using the flow speeds usual in the prior art (below c=2 m/s) (due to Re proportional to the flow speed and the tube interior diameter), it is proposed in this connection that the required Reynolds number Re be ensured by an increased flow speed c* above 2.5 m/s (c*>2.5 m/s) in case of need, preferably above 3 m/s (c*>3 m/s).

TABLE
Tube assignment pattern a with a first tube interior diameter
Tube assignment pattern b with a second tube interior diameter
(first tube interior diameter lesser than second tube interior diameter)

| | Inner tube 20 | | | |
|---|---|---|---|---|
| | tube | Temperature | | |
| Heat | assignment | difference | c, or resp. c*, | Reynolds |
| exchanger | pattern | in ° C. | in m/s | number Re |
| 3 | a | 111.5-117.0 | 3.05 | 45,300 |
| | b | 117.0-122.0 | 2.33 | 52,300 |
| 4 | c | 122.0-131.0 | 3.05 | 56,500 |
| | d | 131.0-142.5 | 2.33 | 74,100 |

The circumstance in the preceding described by the above table, in which essential data for the UHT processing of almond milk with calcium enrichment by the individual heat exchangers, which are concealed behind the heat exchangers 3 and 4 of the pre-heating VEZ and high-heating HZ zone in FIG. 1 schematically depicted in FIG. 1 are listed, shows that for flow speeds c=2.33 m/s, which are already considerably above the usual flow speeds of the prior art which are below c=2 m/s, there is a sufficiently highly turbulent flow in the inner tube 20. For the heat exchanger with the first tube assignment pattern a in heat exchanger 3, a Reynolds number Re below 30,000 (Re<30,000) results at a flow speed of equal to or less than c=2 m/s, therefore not a sufficiently highly turbulent flow. The inventive feature of the increased flow speed is therefore applied. For the heat exchanger with the tube assignment pattern a in heat exchanger 4, a Reynolds number Re of approx. Re=37,000 compared to approx. Re=56,500 (Re=37,000 vs. 56,500) results at a flow speed of equal to or less than c=2 m/s, accordingly a necessarily high but not sufficiently high turbulence of the flow in the interior of the pipe RS compared to the preceding heat exchanger with the second tube assignment pattern b. This shortcoming is remedied in the context of the invention by designing the heat exchanger 4 with the first tube assignment pattern a with an increased flow speed c*=3.05 m/s.

The precipitation temperature Ta is located above approx. 110° C. in the high-heating HE, including the heat-maintenance HH, and possibly already in the pre-heating VE and serves as a criterion for applying the features of claim 1 according to the invention.

During the product passage shown in FIG. 2, the pressure loss increases due to film formation, preferably in the critical section of the UHT system 100 (above approx. 110° C.), which pressure loss becomes apparent through a change of an initial pressure p9 at the outlet of the pressure increasing pump 9, from 22 to 35 bar in the exemplary embodiment, as such with a pressure difference Δp=13 bar. In the same period, an initial temperature difference ΔTo between the raw product RP and the separate heat carrier medium Wm2 of ΔTo=0.4° C. increases to a temperature difference of ΔT=1.9° C. in the high-heating zone HZ, and namely in the heat exchanger 4 of the high-heating zone. This indicates significant film formation in the critical section.

According to the circumstance cited in the preceding as an example (Δp=35−22=13 bar; ΔT−ΔTo=1.9−0.4=1.5° C.), the invention proposes the following method measures for initiating a rinsing and cleaning process according to the insights obtained in the exemplary embodiment:
Upon reaching
   a prescribed pressure difference Δp, relative to an initial pressure p9 at the outlet of the pressure increasing pump 9, and
   a prescribed temperature difference ΔT between the raw product RP and the separate heat carrier medium Wm2 in the high-heating HE, relative to an initial temperature difference ΔTo,
the following steps (i) to (iv) are provided:

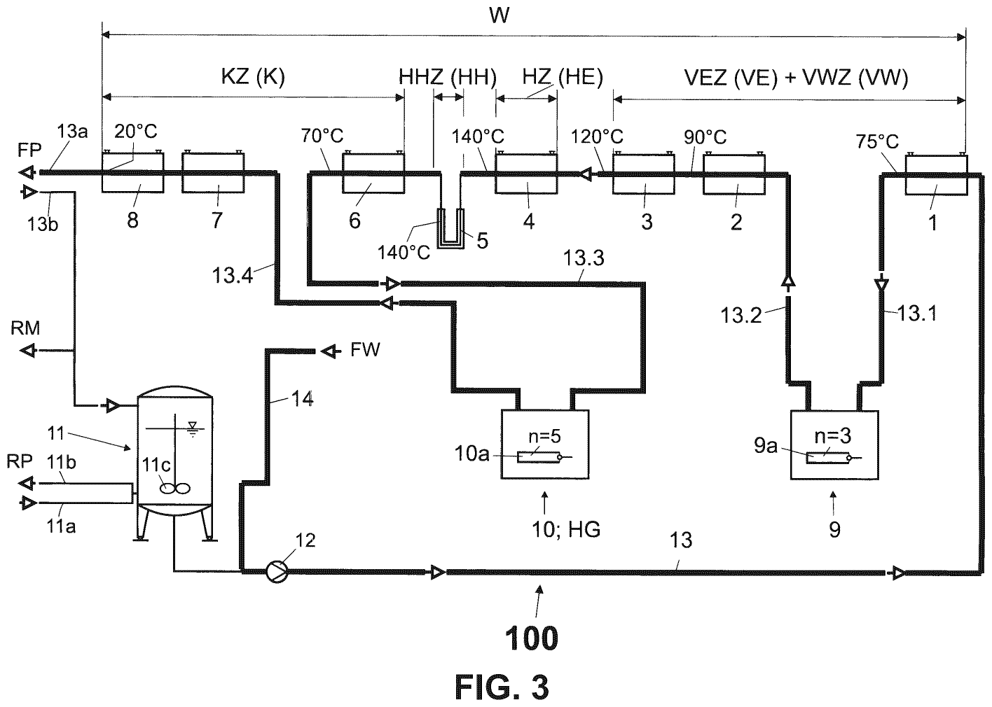

### Product Discharge—FIG. 3

(i) First discharging A1 of the finished product FP from the UHT system 100 into a sterile tank arranged outside the UHT system 100 by means of water FW. The water FW is supplied via the supply line for water 14 of the supply line 13 upstream of the pumping apparatus 12, and the finished product FP leaves the partial section of the UHT system 100 via the outlet 13a. The pressure increasing pump 9 and the homogenizer 10 are in operation according to the invention.

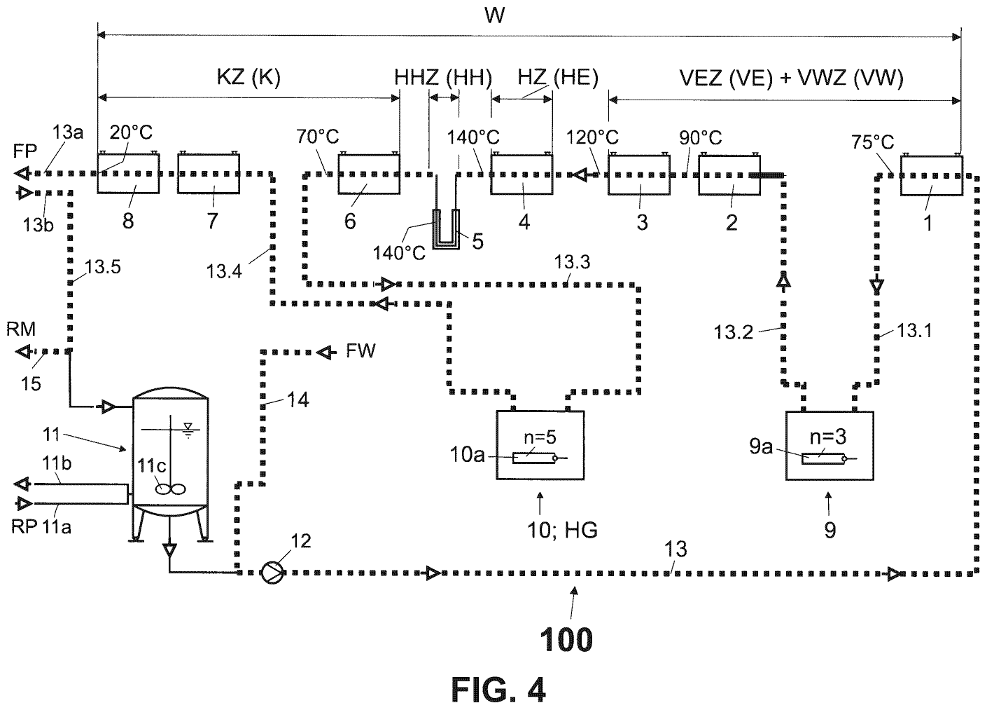

### Discharging Mixed Phase and Driving Water FW—FIG. 4

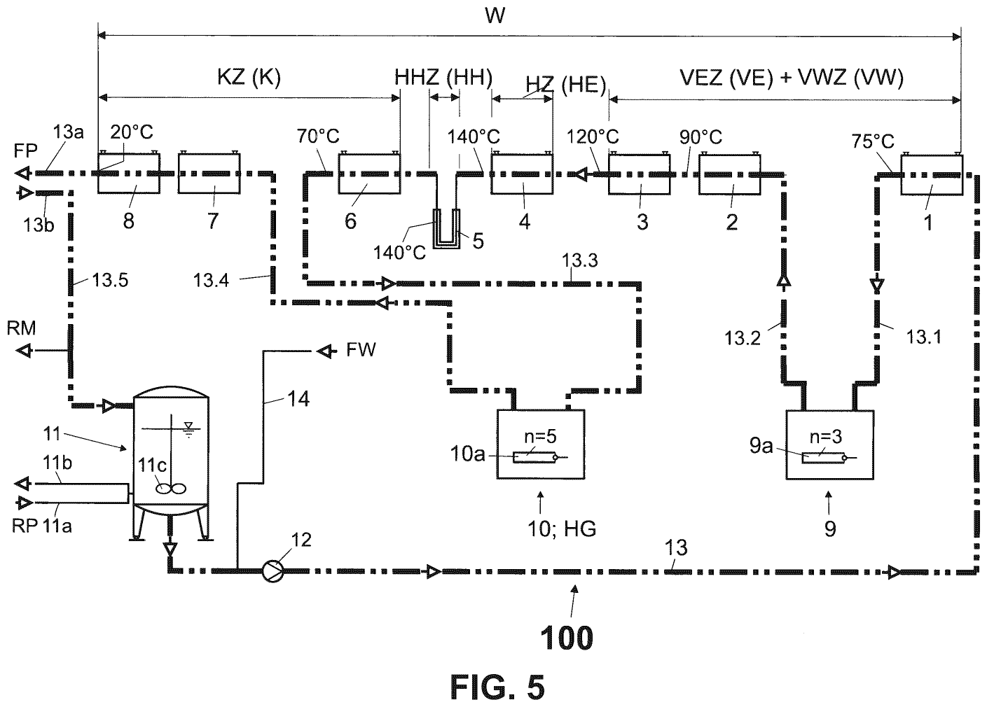

(ii) Second discharging A2 of a mixed phase of finished product FP and water FW by means of a quantity of water FW to be defined in the following into a gully, circumventing the sterile tank, via the outflow line 15 to the gully. The water FW is supplied via the supply line for water 14, and the mixed phase and the defined quantity of water FW leave the partial section of the UHT system 100 as residual product RM via the fifth line segment 13.5 and the outflow line 15 to the gully. The pressure increasing pump 9 and the homogenizer 10 are in operation according to the invention.
   Circulating (Circulation) with Water FW—FIG. 5
(iii) Circulating Z water FW in the UHT system 100 contaminated with raw and/or finished product RP, FP for a circulation time Δt, which results from the complete elimination of the pressure difference Δp to the initial pressure p9 and of the temperature difference ΔT to the initial temperature difference ΔTo. The water FW is circulated via the supply line 13 and the first to fifth line segment 13.1 to 13.5 via the feed tank 11. The pressure increasing pump 9 and the homogenizer 10 are in operation according to the invention, such that the circulating water FW undergoes a continuing sterilization via the thermal treatment W that is in operation continually, at least in the zones outside of the cooling operated with direct water (separate cool water; separate ice water).
   Transitioning the UHT System into Renewed Production Readiness—FIG. 5→FIG. 1
(iv) Transitioning UE the UHT system 100 into renewed production readiness for a prepared batch quantity of raw product RP. The UHT system 100 is loaded with raw product RB from out of the feed tank 11. The pressure-increasing pump 9 and the homogenizer 10 are in operation according to the invention.

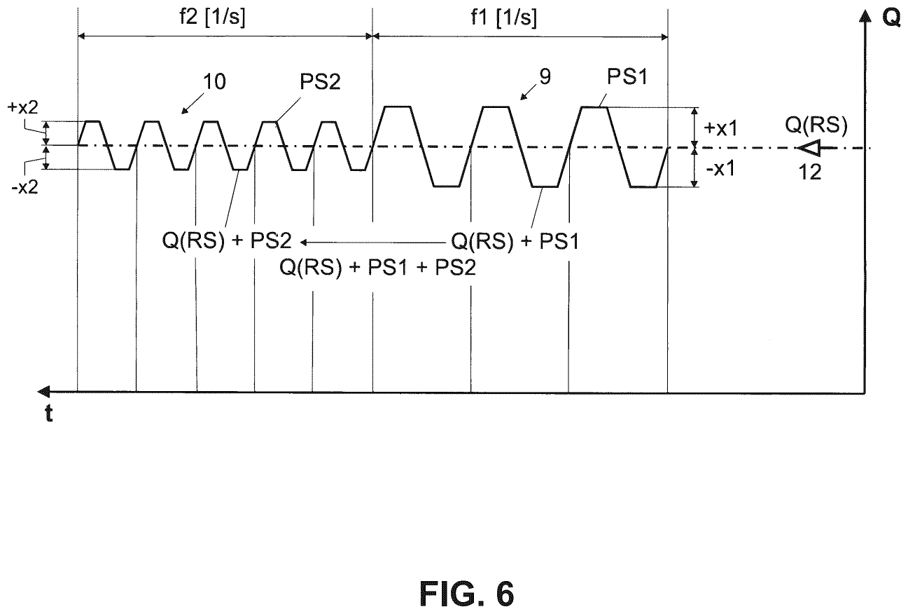

FIG. 6 shows the interplay of the pressure increasing pump 9 with the homogenizer 10 qualitatively. An average volume flow Q of the flow RS in the interior of the pipe (Q (RS)), as it is pumped by the pumping apparatus 12 out of the feed tank 11 into the UHT system 100 approximately continually, is on the y-axis and time t is on the x-axis. The pressure-increasing pump 9 generates the first pulsed flow PS1 depicted in highly simplified form with a first pulse frequence f1, resulting from n=3 single-acting first displacers 9a, for example, (see FIG. 1), which flow PS1 is superimposed on the average volume flow Q (RS) (RS+PS1). The first pulsed flow PS1 has the first pulse maximums (+/−) x1 relating to the volume flow. The homogenizer 10 generates the second pulsed flow PS2 depicted in highly simplified form with a second pulse frequency f2, resulting from n=5 single-acting second displacers 10a, for example, which flow PS2 is superimposed on the average volume flow Q (RS) (RS+PS2). The second pulsed flow PS2 has the second pulse maximums (+/−) x2 relating to the volume flow. The result of the interplay between the nearly continuous original flow RS in the pipe interior, on which is superimposed the first and the second pulsed flow PS1, PS2, a resulting pulsed flow (Q(RS)+PS1+PS2) in the pipe interior escapes the possibilities for a simplified depiction in FIG. 6. Its existence and effectiveness is proved by the practical operation of the UHT system 100 according to the invention described in the preceding.

### Use

The method and the UHT system 100 are suited in a particular manner for producing a drinkable plant-based food product under sterile conditions, such as almond milk enriched with calcium. This almond milk consists
of the continuous phase TF+TM,
   which is composed of a homogeneous mixture of a carrier liquid TF and at least one plantal substrate TM,
      wherein the plantal substrate TM is produced from almonds softened in a liquid provided for this purpose, such as water, then pressed or milled, and the plantal substrate TM is mixed into and homogeneously distributed in the carrier liquid TF, such as water, with a dry substance content of preferably 5 to 10%,
and the dispersed phase B,
   which consists at least of one solid admixture B, with preferably 1,800 to 2,000 mg calcium carbonate/liter of continuous phase,
wherein the dispersed phase with the continuous phase enters into a material solution in the form of the raw product RP.

### LIST OF REFERENCE SIGNS FOR THE ABBREVIATIONS USED

100 partial section of a UHT system
1 (regenerative) first heat exchanger of the pre-warming zone
2 (regenerative) second heat exchanger of the pre-warming zone
3 heat exchanger of the pre-heating zone (with separate hot water circuit)
4 heat exchanger of the high-heating zone (with separate hot water circuit)
5 heat maintainer
6 (regenerative) first heat exchanger of the cooling zone
7 second heat exchanger of the cooling zone (with separate cool water)
8 third heat exchanger of the cooling zone (with separate ice water)
9 pressure-increasing pump
9a first displacer (three single-acting)
10 homogenizer working aseptically or not aseptically, depending on the arrangement
10a second displacer (five single-acting)
11 feed tank
11a inlet to the feed tank
11b outlet from feed tank
11c stirring or mixing apparatus
12 pumping apparatus
13 supply line
13a outlet
13b inlet
13.1 first line segment
13.2 second line segment
13.3 third line segment
13.4 fourth line segment
13.5 fifth line segment
14 supply line for water
15 outflow line to gully
20 inner tube
A1 first discharge
A2 second discharge
B admixture (e.g. calcium)
FP finished product, sterilized, homogenized=drinkable plant-based food product (e.g. almond milk with calcium enrichment)
FW water
HE high-heating
HG homogenization
HZ high-heating zone
HH heat-maintenance
HHZ heat-maintenance zone
K cooling
KZ cool zone
PS1 first pulsed flow (pressure increasing pump 9)
PS2 second pulsed flow (homogenizer 10)
Q volume flow (average flow in interior of pipe)
Re Reynolds number
RM residual product (mixed phase; water)
RP raw product, untreated=drinkable plant-based food product, untreated
RS flow in interior of pipe
Ta precipitation temperature (e.g. ≥110° C. for calcium in almond milk)
TF carrier liquid (e.g. water)
TM plantal substrate (e.g. milled almonds)
ΔT temperature difference (high-heating: raw product/separate heat carrier medium)
ΔTo initial temperature difference (high-heating: raw product/separate heat carrier medium)
UE transitioning
VE pre-heating
VEZ pre-heating zone
VW pre-warming
VWZ pre-warming zone
W thermal treatment
Wm1 regenerative heat carrier medium
Wm2 separate heat carrier medium
Z circulating
C* increased flow speed
f1 first pulse frequency
f2 second pulse frequency
n number
p9 initial pressure (at outlet of the pressure increasing pump 9)
Δp pressure difference (relative to counter pressure p9)
t time
Δt circulation time
x1 first pulse maximum relating to the volume flow
x2 second pulse maximum relating to the volume flow

1. A method for UHT processing of a drinkable plant-based food product under sterile conditions,
in which the food product (RP; FP) in the form of a raw product (RP) used, a homogeneous mixture of a carrier liquid (TF) and at least one plantal substrate (TM), constitutes a continuous phase (TF+TM), and at least one solid admixture (B) is fed additively into the continuous phase (TF+TM), said admixture (B) constituting a dispersed phase (B) and, with the continuous phase (TF+TM), entering into a material solution in the form of the raw product (RP),
in which until a drinkable finished product (FP) is produced, the raw product (RP) is subjected, in the sequence mentioned in the following, to a thermal treatment (W) at least by a pre-warming (VW), a pre-heating (VE), a high-heating (HE), a heat-maintenance (HH) and a cooling (K), and in the course of the thermal treatment (W) undergoes a homogenization (HG), and
in which the thermal treatment (W) occurs in each case by indirect heat exchange between a product-side flow (RS) in the interior of a pipe and a heat carrier medium (Wm1, Wm2) external to the pipe,
characterized in that
at least in one section of the thermal treatment (W), in which the at least one admixture (B) begins to precipitate out of the material solution, the raw product (RP), above a precipitation temperature (Ta),
on the one hand, a first pulsed flow (PS1) is applied to the product-side flow (RS) in the interior of the pipe in the course of a pressure increase process using a pressure-increasing pump (9), said flow (PS1) is superimposed on a second pulsed flow (PS2) within the product side flow (RS) in the interior of the pipe resulting from the homogenization (HG) by means of a homogenizer (10), and
on the other hand, the product-side flow (RS) in the interior of the pipe is designed for a highly turbulent flow with a Reynolds number (Re) above 30,000 (Re>30,000).

2. The method according to claim 1,
characterized in that
the Reynolds number (Re) is designed in a value range preferably between 35,000 and 80,000 (35,000≤Re≤80,000) and particularly preferably between 50,000 and 80,000 (50,000≤Re≤80,000).

3. The method according to claim 1,
characterized in that
the required Reynolds number (Re) is ensured by an increased flow speed (c*) above 2.5 m/s in case of need (c*>2.5 m/s).

4. The method according to claim 3,
characterized in that
the increased flow speed (c*) is designed in a range above 3.0 m/s (c*>3.0 m/s).

5. The method according to claim 1,
characterized in that
first pulse maximums (x1) relating to the volume flow of the first pulsed flow (PS1) and second pulse maximums (x2) relating to the volume flow of the second pulsed flow (PS2) are different in size.

6. The method according to claim 1,
characterized in that
the first pulse maximums (x1) relating to the volume flow of the first pulsed flow (PS1) have a first pulse frequency (f1) and second pulse maximums (x2) relating to the volume flow of the second pulsed flow have a second pulse frequency (f2), and the first and the second pulse frequency (f1, f2) are different in size.

7. The method according to claim 1,
characterized in that
first pulse maximums (x1) relating to the volume flow of the first pulsed flow (PS1) and second pulse maximums (x2) relating to the volume flow of the second pulsed flow (PS2) are different in size, and
the first pulse maximums (x1) relating to the volume flow of the first pulsed flow (PS1) have a first pulse frequency (f1) and second pulse maximums (x2) relating to the volume flow of the second pulsed flow have a second pulse frequency (f2), and the first and the second pulse frequency (f1, f2) are different in size.

8. The method according to claim 6,
characterized in that
the first pulse frequency (f1) is smaller than the second pulse frequency (f2).

9. The method according to claim 6,
characterized in that
the first pulse frequency (f1) has a 3 to 5 relationship to the second pulse frequency (f2) (f1/f2=3/5).

10. The method according to claim 1,
characterized in that
the precipitation temperature (Ta) is located above 110° C. in the high-heating (HE) and possibly already in the pre-heating (VE) and serves as a criterion for applying the features of claim 1 according to the invention.

11. The method according to claim 1,
characterized in that
upon reaching
a prescribed pressure difference (Δp), relative to an initial pressure (p9) at the outlet of the pressure increasing pump (9), and
a prescribed temperature difference (ΔT) between the raw product (RP) and a separate heat carrier medium (Wm2) in the high-heating (HE), relative to an initial temperature difference (ΔTo),
the following steps (i) to (iv) are provided:
(i) first discharging (A1) of the finished product (FP) from the UHT system (100) into a sterile tank arranged outside the UHT system (100) by means of water (FW);
(ii) second discharging (A2) of a mixed phase of finished product (RP) and water (FW) into a gully circumventing the sterile tank by means of a subsequently defined quantity of water (FW);
(iii) circulating (Z) water (FW) within the UHT system (100) contaminated with raw and/or finished product (RP; FP) for a circulation time (Δt) that results from the complete elimination of the pressure difference (Δp) to the initial pressure (p9) and of the temperature difference (ΔT) to the initial temperature difference (ΔTo), and
(iv) transitioning (UE) the UHT system (100) into renewed production readiness for a prepared batch-quantity of raw product (RP).

12. The method according to claim 11,
characterized in that
in the course of the circulating (Z), the circulated volume flow of water (FW) is incrementally reduced by the pressure increasing pump (9) in conjunction with the homogenizer (10),
the decrease of the pressure difference (Δp) and of the temperature difference (ΔT) in this context is monitored and in each case maximum gradients are determined, and
the circulating (Z) is continued under the circulation conditions at the optimum of the determined maximums until the initial pressure (p9) and the initial temperature difference (ΔTo) are reached.

13. A UHT system for carrying out the method according to claim 1 for UHT processing of a drinkable plant-based food product under sterile conditions,
wherein the food product (RP;FP) in the form of a raw product (RP) used, a homogeneous mixture of a carrier liquid (TF) and at least one plantal substrate (TM), constitutes a continuous phase (TF+TM), and at least one solid admixture (B) is fed additively into the continuous phase (TF+TM), said admixture (B) constituting a dispersed phase (B) and, with the continuous phase (TF+TM), entering into a material solution in the form of the raw product (RP),
wherein the UHT system (100) is designed for thermal treatment (W) of the raw product (RP) with the objective of producing a drinkable finished product (FP) with, seen from the flow direction of the raw product, a pre-warming zone (VWZ) having at least one first (1) and if necessary a second heat exchanger (2) of the pre-warming zone, a pre-heating zone (VEZ) having at least one third heat exchanger (3) of the pre-heating zone, with a high-heating zone (HZ) having at least one heat exchanger (3) of the high-heating zone, with a heat-maintenance zone (HHZ) having at least one heat-maintainer (5), with a cooling zone (KZ) having at least one first heat exchanger (6) of the cooling zone and, if necessary, a second and a third heat exchanger (7, 8) of the cooling zone, and in the course of the thermal treatment (W) with a homogenizer (10),
wherein the heat exchangers (1-4; 6-8) are designed in each case as shell-and-tube heat exchangers and are arranged in series connection, in which an indirect heat exchange occurs between the raw product (RP) which flows in multiple inner tubes (20) arranged in parallel and there constitutes a flow (RS) in the interior of a pipe, and a heat carrier medium (Wm1, Wm2) that flows externally to the pipe around the inner tube (20),
characterized in that
a feed tank (11) is provided that is fluidically connected with the first heat exchanger (1) of the pre-warming zone via a supply line (13) in which a pumping apparatus (12) is arranged,
a supply line for water (14) flows into the supply line (13) upstream of the pumping apparatus (12),
the feed tank (11) is integrated in fluid communication into a circulation line system comprising the heat exchangers (1-4; 6-8) and the heat-maintainer (5) through to a sterile tank and a fifth line segment (13.5) that circumvents the sterile tank by bypass leading to the feed tank (11), and the supply line (13), and
a pressure increasing pump (9) is arranged downstream from the first heat exchanger (1) of the pre-warming zone and the homogenizer (10) is arranged downstream from the first heat exchanger (6) of the cooling zone.

14. The UHT system according to claim 13,
characterized in that
in the flow-in section of the fifth line segment (13.5), an outflow line (15) to a gully opens out into the feed tank (11) from the fifth line segment (13.5).

15. The UHT system according to claim 13,
characterized in that
the pressure increasing pump (9) is designed as a reciprocating pump with three single-acting pistons.

16. The UHT system according to claim 13,
characterized in that
the homogenizer (10) is designed as a reciprocating pump with five single-acting pistons.

17. The UHT system according to claim 13,
characterized in that
the pressure increasing pump (9) is designed for a counter pressure that ensures a Reynolds number (Re) of above 30,000, or an increased flow speed (c*) of above 2.5 m/s, and in that the product-exposed sections of the UHT system (100) between the pressure increasing pump (9) and the homogenizer (10) are designed for this counter pressure.

18. The UHT system according to claim 13,
characterized in that
the inner tubes (20) of the shell-and-tube heat exchangers (1-4; 6-8) in each case have the features of the subject-matter of EP 1 567 818 B1.

19. A drinkable plant-based food product such as almond milk consisting of the continuous phase (TF+TM), which consists of a homogeneous mixture of a carrier liquid (TF) and at least one plantal substrate (TM), wherein the plantal substrate (TM) is produced from almonds softened in a liquid provided for this purpose, such as water, then pressed or milled, and the plantal substrate (TM) is mixed into and homogeneously distributed in the carrier liquid (TF), such as water, with a dry substance content of 5 to 10%, and the dispersed phase (B), which consists at least of one solid admixture (B), with 1,800 to 2,000 mg calcium carbonate/liter of continuous phase, wherein the dispersed phase (B) with the continuous phase (TF+TM) enters into a material solution in the form of the raw product (RP), and produced through thermal treatment (W) in the UHT system according to claim 13.
